(19) United States
(12) Patent Application Publication
(10) Pub. No.: US 2019/0160588 A1
(43) Pub. Date: May 30, 2019

(54) ROBUST BONDING OF SINTERED TUNGSTEN CARBIDE

(71) Applicant: SYNCRUDE CANADA LTD. in trust for the owners of the Syncrude Project as such owners exist now and, Fort McMurray (CA)

(72) Inventor: HUGH ROTH, Edmonton (CA)

(21) Appl. No.: 16/182,284

(22) Filed: Nov. 6, 2018

Related U.S. Application Data
(60) Provisional application No. 62/591,032, filed on Nov. 27, 2017.

(51) Int. Cl. B23K 20/24; B23K 20/12

(52) U.S. Cl. CPC B23K 20/24; B23K 20/1205

(57) ABSTRACT

A method for bonding a cemented or sintered tungsten carbide element to a structural component is provided comprising cladding at least one surface of the cemented or sintered tungsten carbide element with a metal layer using hot isostatic pressing; and friction welding a cladded surface of the cemented or sintered tungsten carbide element to the structural component.

### FIELD OF THE INVENTION

The present application relates generally to a method for bonding a cemented or sintered tungsten carbide element to a structural component for improved wear resistance of equipment or equipment parts that are typically used in the mining industry, for example, the oil sands mining industry.

### BACKGROUND OF THE INVENTION

Oil sands deposits are a loose (or unconsolidated) sand deposit which contains bitumen (a heavy, complex hydrocarbon or petroleum), fine clays and a small amount of water. The bitumen content of oil sands normally ranges from 8 to 12% but can be as high as 14%. Less than about 20% of Alberta's bitumen reserves are close enough to the surface to be mined. Mined oil sands deposits are normally less than 50 meters below the surface but can be as deep as 75 meters below grade. Anything deeper cannot be economically mined since too much waste material needs to be removed before the bitumen-rich oil sands can be accessed.

Surface mining is defined as the extraction of ore from an open pit or burrow. Surface mining is sometimes known as open-pit, open-cut or opencast mining and is only commercially viable if the deposit is located relative close to the surface. The deposit is excavated using large shovels, which dump the ore onto large haul trucks. The trucks then transport the oil sands to a slurry preparation plant. Oil sands mining fleets are subjected to some of the harshest conditions on earth. Equipment must be able to sustain brutally cold winters, abrasive silica sand, sticky bitumen and unstable ground conditions.

Once the mined oil sands is hauled to the slurry preparation plant, the large clumps of ore are broken down (e.g., by crushers) and then mixed with a large volume of hot/warm water, producing a pumpable slurry. The slurry must then be pumped for several kilometers to a bitumen separation plant. Once again, due to the abrasion/corrosive nature of oil sand slurries, equipment necessary to pump such a slurry, e.g., slurry pumps, pipelines, etc., must be able to withstand such harsh materials.

In some instances, it may be desirable to remove the larger aggregates present in oil sand slurry prior to pipelining in order to avoid blockage or damage of downstream equipment, e.g., pump component wear. Thus, vibrating screens may be used at various points during slurry preparation to reject larger lumps of oil sand, rocks and other aggregates, which are large enough to block or damage downstream equipment, prior to pipeline conditioning. Screens may also be used to further screen oil sand tailings slurry prior to treating/disposing same. However, once again, oil sand slurry is extremely heavy and abrasive due to the large amount of sand, gravel and crushed rock contained therein.

One recent development in improving wear of oil sands equipment involves the use of wear resistant tiles or inserts made from a hard material comprising cemented or sintered tungsten carbide. Cemented or sintered tungsten carbide is extremely wear resistant; however, its use has been somewhat limited by existing carbide attachment methods that are used to join sintered tungsten carbide to structural components. Prior art attachment methods generally involve three main bonding technologies: brazing, adhesives, and mechanical attachment.

Brazing is a metal-joining process in which two or more metal items are joined together by melting and flowing a filler metal into the joint, the filler metal having a lower melting point than the adjoining metal. Typical brazing material comprises brazing alloys, silver, gold, copper, nickel or tri-braze. However, the brazing of cemented or sintered tungsten carbide to structural materials may result in high residual stress, braze defects, service temperature limitations and corrosion. Adhesives such as epoxy resins can be used to glue tungsten carbide to another metal surface. However, some drawbacks with adhesives are glue quality, service temperature limitations, glue degradation by water and lack of repair options. Finally, mechanical attachment (e.g. dove tail joints, bolted connections, etc.) may result in added costs, partial utilization of tungsten carbide and stress concentrations.

Thus, there is a need for an improved method for bonding sintered tungsten carbide to structural components to improve the wear of equipment used in the mining industry, and, in particular, the oil sands mining industry, for example, screen cloths of screening equipment, crusher teeth and hammers of crushers, slurry pump parts, pipelines, and the like.

### SUMMARY OF THE INVENTION

The current application is directed to a method for bonding wear resistant elements such as tiles or inserts comprising cemented or sintered tungsten carbide to a structural component, generally, a cast of carbon steel, stainless steel, or other strong steel, to improve wear resistance of the structure under harsh conditions.

Broadly stated, in one aspect of the present invention, a method for bonding a cemented or sintered tungsten carbide element to a structural component is provided comprising:
cladding at least one surface of the cemented or sintered tungsten carbide element with a metal layer using hot isostatic pressing; and
friction welding a cladded surface of the cemented or sintered tungsten carbide element to the structural component.

In one embodiment, the structural component is manufactured as a single unit that is cast or forged from carbon steel, low alloy steel, stainless steel, or other strong material (e.g. nickel or cobalt based alloys). In one embodiment, the cemented or sintered tungsten carbide elements are in the shape of tiles or inserts. In one embodiment, the cemented or sintered carbide elements are clad in a metal such as nickel or cobalt alloys, although any material that does not degrade the cemented or sintered tungsten carbide can be used.

Additional aspects and advantages of the present invention will be apparent in view of the description, which follows. It should be understood, however, that the detailed description and the specific examples, while indicating preferred embodiments of the invention, are given by way of illustration only, since various changes and modifications will become apparent to those skilled in the art from this detailed description.

### BRIEF DESCRIPTION OF THE DRAWINGS

FIG. 1 is a perspective view of a grader blade having been modified by the present invention.

FIG. 2 is a cross-sectional view of the grader blade shown in FIG. 1.

FIG. 3 is a cross-sectional view of a clad sintered carbide tile of the present invention.

FIG. 4 is a photograph of a weld produced by linear friction welding according to the process of the present invention.

### DETAILED DESCRIPTION OF PREFERRED EMBODIMENTS

The detailed description set forth below in connection with the appended drawings is intended as a description of various embodiments of the present application and is not intended to represent the only embodiments contemplated. The detailed description includes specific details for the purpose of providing a comprehensive understanding of the present application. However, it will be apparent to those skilled in the art that the present application may be practised without these specific details.

The present application relates generally to a method for bonding a cemented or sintered tungsten carbide element to a structural component for improved wear resistance of equipment or equipment parts that are typically used in the mining industry such as the oil sands mining industry. Examples of structural components that could benefit from the present invention include impact hammers of rotary impact crushers, centrifugal slurry pump parts, for example, suction liners and the like, screen cloths of vibrating screens, rotary screens, etc. Generally, structural components are made from carbon steel, low allow steel, stainless steel, or other strong materials such as nickel and cobalt alloys could be candidates as well.

As used herein, “cemented or sintered tungsten carbide” refers to a product comprised of tungsten carbide particles held together by an interpenetrating film of cobalt or cobalt alloy. The various grades of cemented or sintered tungsten carbide depends on the size of the tungsten carbide particles, the percentage of alloy binding phase, and the amount of alloying in the binder phase.

As used herein, “hot isostatic pressing” or “HIP” involves the simultaneous application of high pressure (15,000 to 45,000 psi) and elevated temperatures (up to 2500° C.) in a specially constructed vessel. The pressure is usually applied with an inert gas such as argon, and so is “isostatic”. Under these conditions of heat and pressure internal pores or defects within a solid metal body collapse and diffusion bonding occurs at the interfaces. Encapsulated powder and sintered components can also be fully densified to give improved mechanical properties. At least one surface of the cemented or sintered tungsten carbide material will be clad with a layer of suitable metallic alloy to enable subsequent friction welding while not causing undesired metallurgical reactions at the metal/tungsten carbide interface. It is understood, however, that more than one surface of the cemented or sintered tungsten carbide material could be clad.

As used herein, “friction welding” or “FRW” is a solid-state welding process that generates heat through mechanical friction between work pieces in relative motion to one another, with the addition of a lateral force called “upset” to plastically displace and fuse the materials. Because no melting occurs, friction welding is not a fusion welding process in the traditional sense, but more of a forge welding technique. The combination of fast joining times (on the order of a few seconds), and direct heat input at the weld interface, yields relatively small heat-affected zones. Friction welding techniques are generally melt-free, which mitigates grain growth in engineered materials, such as high-strength heat-treated steels. Another advantage of friction welding is that it allows dissimilar materials to be joined.

As used herein, “linear friction welding” is a type of friction welding where the accelerated component oscillates with linear movements. In linear friction welding, one of the components to be joined is firmly clamped. The other component is accelerated with a linear movement. Then the two parts are pressed together with high pressure. This creates friction heat. The resulting weld flash is trimmed off the end(s). Linear friction welding results in friction over the entire welding area. This means that difficult-to-process materials, such as titanium or nickel-based alloys can be joined easily and quickly. Linear friction welding can join dissimilar metals not considered compatible using conventional welding methods and is able to join a nearly limitless number of shapes and complex part geometries.

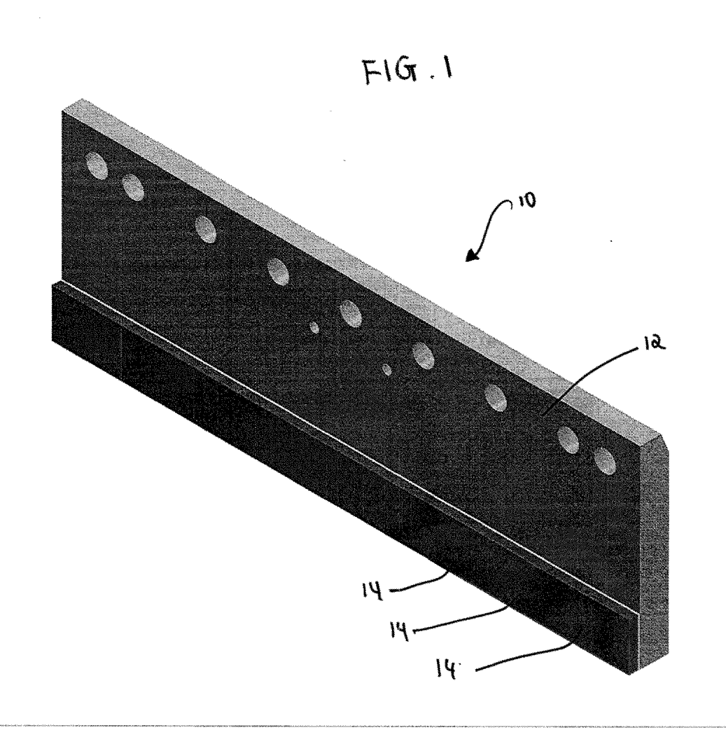

In the present invention, HIP cladding of a cemented or sintered tungsten carbide element is used to produce at least one surface that can be welded to a structure made of structural steel and the like by friction welding such as linear friction welding to produce a robust bond with minimal residual stress. FIG. 1 shows a conventional grader blade made of carbon steel as an example of a structural component that can be modified by the present invention. To improve the wear resistance of the grader blade, the active face of the bottom portion of the blade is reinforced with cemented or sintered tungsten carbide tiles according to the present invention.

In particular, the cemented or sintered tungsten carbide tiles are first subjected to hot isostatic pressing (HIP) in order to clad at least one surface (face) of the cemented or sintered tungsten carbide tile with a metal that is compatible with friction welding. In one embodiment, a metal enclosure or container may be used, into which the cemented or sintered tungsten carbide tile can be placed. The metal enclosure is sized and shaped such that a space between one or more than one of the tile surfaces and the metal enclosure is formed. The metal enclosure is generally made from a high quality steel that must be strong enough to maintain shape and dimensional control but also be soft and malleable at the HIP temperature. A metal powder, for example, a nickel or cobalt alloy powder, is then added to the formed space(s) to fill the space(s), the metal enclosure sealed, and HIP is applied. The powder is converted into a fully dense layer that clads the desired surface(s) of the cemented or sintered tungsten carbide tile and the metal enclosure is then removed from the clad tungsten carbide tile.

In another embodiment, in particular, when it is desirable to clad all surfaces of the cemented or sintered tungsten carbide tile, an envelope or can made of a nickel or cobalt alloy can be used to envelop the cemented or sintered tungsten carbide tile, which is then placed in a pressure vessel and subjected to HIP. The envelope/can then diffusion bonds to the cemented or sintered tungsten carbide tile, creating a tungsten carbide tile that is clad with the nickel or cobalt alloy at the desired surfaces.

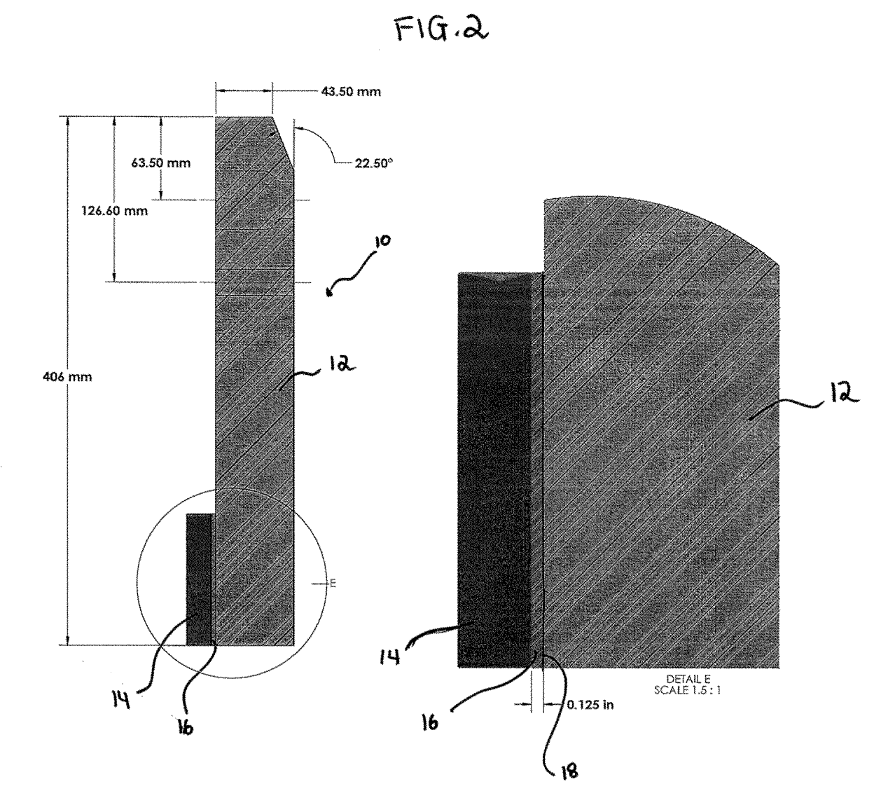

When at least one surface of the cemented or sintered tungsten carbide tile is clad, the cemented or sintered tungsten carbide tile is then friction welded to the front face of the grader blade via the clad surface. As previously mentioned, FIG. 1 shows a grader blade 10 that has been modified by the present invention to improve wear resistance and, hence, life span of the blade bottom front face. In particular, grader blade 10 comprises blade element 12, which is typically made from a low alloy steel, and a number of cemented or sintered tungsten carbide tiles 14 that have been friction welded to blade element 12 for protection. In particular, the cemented or sintered tungsten carbide tiles 14 have been first clad with an alloy on one surface so that the tile is now compatible for friction welding via the clad surface. FIG. 2 is a cross-section of grader blade 10, which shows cemented or sintered tungsten carbide tile 14 having been clad with an alloy (layer 16) and friction welded (layer 18) to blade element 12.

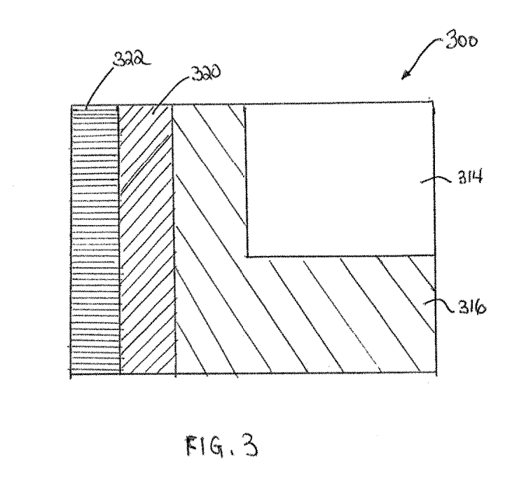

In another embodiment, it may be desirable to use a tungsten carbide element which has multi-layered cladding. FIG. 3 shows a tungsten carbide tile 314, which was first clad with a nickel-cobalt ferrous alloy using hot isostatic pressing to form alloy layer 316. The thus clad tungsten carbide tile was then placed in a container that was made from a mild low-carbon steel, in this instance, “1018 Mild Steel”. The clad tungsten carbide tile was placed in the container such that there was a space between the front inner surface of the container and the alloy cladding (layer 316). Stainless steel powder (“Type 316 Stainless Steel”) was poured into the container to fill the space and the clad tungsten carbide tile was then subjected to hot isostatic pressing to add a stainless steel cladding layer 320 and third cladding layer 322, which represents the welded mild steel container. Thus, the final product, multi-layer cladded tungsten carbide tile 300, is comprised of tungsten carbide tile 314, the alloy layer 316, stainless steel layer 320 and mild steel layer 322.

The multi-layer cladded tungsten carbide tile 300 was then welded to a mild low-carbon steel element, a block of 1018 Mild Steel, using linear friction welding. The faying surface of the mild steel block was mechanically cleaned with a wire brush grinder to remove oxides. Then, the faying surfaces of both the mild steel block and the multi-layer cladded tungsten carbide tile 300, i.e., the mild steel layer 322, were wiped clean with acetone and a lint-free rag. Several different weld parameters combinations were tested and after welding the final products were cut for macro-inspection and a bend test was completed. The weld parameters tested are shown in Table 1 below.

TABLE 1

| | First | Second | | | | Upset | Machine | Measured |
|---|---|---|---|---|---|---|---|---|
| | Friction | Friction | Forge | Frequency | Amplitude | Target | Upset | Upset |
| Weld# | (MPa) | (MPa) | (MPa) | (Hz) | (mm) | (mm) | (mm) | (mm) |
| 1 | 80 | 80 | 130 | 60 | 2 | 2 | — | — |
| 2 | 80 | 80 | 130 | 60 | 2 | 2 | 2.36 | — |
| 3 | 80 | 80 | 130 | 60 | 2 | 3 | 3.36 | 3.56 |
| 4 | 80 | 80 | 130 | 60 | 2 | 4 | 4.40 | 4.55 |
| 5 | 80 | 80 | 130 | 60 | 2 | 5 | 5.46 | 5.59 |
| 6 | 80 | 80 | 130 | 60 | 2 | 2 | 2.46 | 2.60 |
| 7 | 80 | 80 | 130 | 60 | 2 | 4 | 4.48 | 4.65 |
| 8 | 100 | 150 | 180 | 60 | 2 | 2 | 2.34 | 2.44 |
| 9 | 100 | 150 | 180 | 60 | 2 | 4 | 4.61 | 4.75 |

There was some concern that the multi-layered cladding may result in several points of failure during the linear friction welding. First, delamination between the cladding and the tungsten carbide may occur as a result of the violent oscillation, which could detrimentally affect weld quality. Second, the different materials in the cladding (i.e., different material layers of cladding) could disrupt the welding process. For example, if the outer mild steel layer 322 is fully extruded in to flash, the sudden, in-process change to welding the stainless steel layer 320 may cause a significant alteration to welding variables such as weld temperature or friction force.

As a result of these concerns, it was decided that welding would begin with a low upset target to minimize the risk of failure. Welding pressures and surface velocity were chosen based on prior steel weld knowledge and were held constant for the initial set of welds #1 to 7. The weld testing began with a low upset target of 2 mm (welds #1 and 2). The next three welds, welds #3, 4 and 5, the upset target was increased by 1 mm each to a maximum of 5 mm while all other weld parameters were left unchanged. As upset increased, the amount of cladding extruded in to flash also increased, with the higher upset target welds having stainless-steel being extruded in to flash as well. However, even on the highest upset weld of 5 mm, weld #5, there was no indication of delamination or defects in the weld region.

Two repeats were made, one of lower upset of 2 mm and the second at 4 mm (welds #6 and 7, respectively). While weld #6 was not sectioned for inspection, additional time was taken to cut a bend test from weld #7 to mechanically test weld quality. A lateral cross section of the full weld width was taken which was then slowly forced to bend. Very shortly after applying load, the part snapped in two. Inspection of the now broken sample clearly showed the failure location was the bond between the stainless-steel layer and the alloy cladding. This result shows that the weld is stronger than the bonds between cladding and welds free of defects could be considered good.

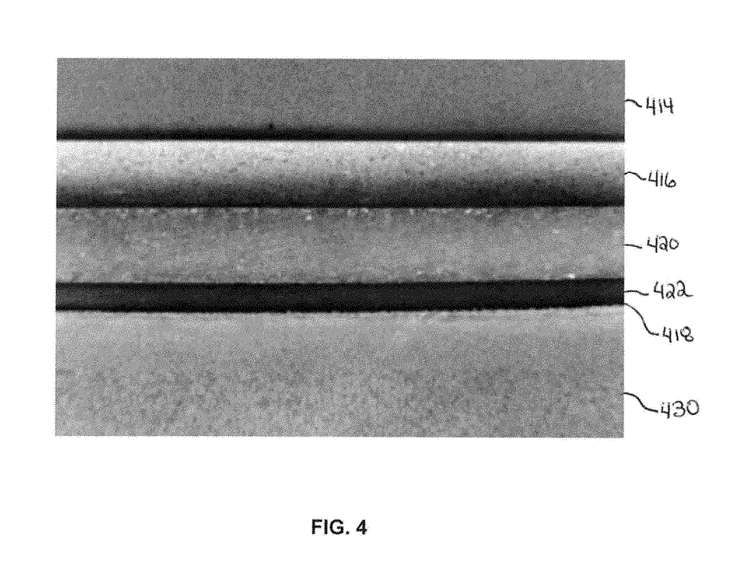

To explore other parameter combinations, the last two welds, welds #8 and 9, were run at a higher weld pressure. The purpose of this was to minimize weld time and potentially reduce the heat affected zones. A target upset of 2 mm and 4 mm was used for welds #8 and 9, respectively. Both welds went very well, and the macro results were unique compared to previous welds. For weld #8, the mild steel cladding layer was extremely uniform and the heat-affected zone was reduced. The oscillation time for weld #8 was 1.80 seconds. FIG. 4 is a photograph of weld #8, where top layer 414 is the tungsten carbide tile, second layer 416 is the alloy cladding, third layer 420 is the stainless steel cladding, and fourth layer 422 is the mild steel layer, all of which form the multi-layer cladded tungsten carbide tile. The bottom layer 430 is the mild steel of the mild steel block. As shown in the photograph, the weld 418 between the fourth layer 422 and bottom layer 430 is very uniform and there is no apparent separation between the layers of the cladded sintered tungsten carbide tile.

While challenges were anticipated during these tests, given the multi-layered cladding material, nevertheless, the welds ran well and good results were obtained. Incremental increases to the upset target allowed for process stability to be maintained while minimizing the risk to the parts. The final two welds, #8 and #9, that were run at higher weld pressures were found to have more uniform interfaces than their lower pressure counterparts. It is likely that while a higher welding pressure may increase the risk of delamination due to the inherently more aggressive welding process, material is more evenly upset across the width of the weld. Nevertheless, in general, the cladding layers were all shown to hold up well to the linear friction welding forces without delamination. Macro-inspection revealed that delamination between the cladded layers did not occur, even at higher upset targets or higher weld pressures. Additionally, all three layers distinctly remained in the weld region with only the highest upset welds having pushed the majority of the outermost layer in to flash. The results of these tests sufficiently display the feasibility of using linear friction welding to join two materials together, as well as demonstrated the robustness of the process on these parts.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The scope of the claims should not be limited by the preferred embodiments set forth in the examples, but should be given the broadest interpretation consistent with the description as a whole.

1. A method for bonding a cemented or sintered tungsten carbide element to a structural component, comprising:
cladding at least one surface of the cemented or sintered tungsten carbide element with a metal layer using hot isostatic pressing; and
friction welding a cladded surface of the cemented or sintered tungsten carbide element to the structural component.

2. The method as claimed in claim 1, wherein the friction welding is linear friction welding.

3. The method as claimed in claim 1, wherein the structural component is cast or forged from carbon steel, low alloy steel, stainless steel, a nickel alloy, or a cobalt alloy.

4. The method as claimed in claim 1, wherein the cemented or sintered tungsten carbide element is shaped like a tile.

5. The method as claimed in claim 1, wherein the metal layer comprises an iron, nickel, or cobalt alloy.

6. The method as claimed in claim 1, wherein the cemented or sintered tungsten element is placed in a metal container having an interior dimension larger than the outer dimension of the cemented or sintered tungsten carbide element to form a space for adding a metal powder prior to using hot isostatic pressing to form the metal layer.

7. The method as claimed in claim 6, wherein the metal powder is an iron, nickel, or cobalt alloy powder.

8. The method as claimed in claim 6, wherein the metal container is comprised of a high quality steel which is removed after hot isostatic pressing.

9. The method as claimed in claim 6, wherein the metal container is comprised of a mild steel which diffusion bonds to the metal powder during hot isostatic pressing and forms the cladded surface.

10. The method as claimed in claim 1, wherein the metal layer is formed by surrounding the cemented or sintered tungsten carbide element with a container comprised of an iron, nickel, or cobalt alloy prior to using hot isostatic pressing.

11. The method as claimed in claim 1, wherein the metal layer comprises a nickel-cobalt ferrous alloy.

12. The method as claimed in claim 1, wherein the metal layer comprises stainless steel.
